(19) United States
(12) Patent Application Publication
(10) Pub. No.: US 2007/0013310 A1
(43) Pub. Date: Jan. 18, 2007

(54) Plasma display panel and method of manufacturing the same

(76) Inventor: Yoon Kwan Lee, Gwangmyeong-si (KR)

Correspondence Address: FLESHNER & KIM, LLP, P.O. BOX 221200, CHANTILLY, VA, 20153, US

(21) Appl. No.: 11/478,325

(22) Filed: Jun. 30, 2006

(30) Foreign Application Priority Data
Jul. 1, 2005 (KR) 10-2005-0059192

(51) Int. Cl. H01J 17/49

(52) U.S. Cl. 313/586

(57) ABSTRACT

A plasma display panel and a method of manufacturing the same are disclosed. The plasma display panel uses a photosensitive barrier rib containing nano-powder.

This application claims the benefit of the Korean Patent Application No. 10-2005-0059192, filed on Jul. 01, 2005, which is hereby incorporated by reference as if fully set forth herein.

### BACKGROUND OF THE INVENTION

1. Field of the Invention

The present invention relates to a flat panel display apparatus, and more particularly, to a plasma display panel and a method of manufacturing the same.

2. Discussion of the Related Art

Generally, plasma display panels are display apparatuses in which ultraviolet rays generated by gas discharge excite phosphors, thus causing the phosphors to generate visible rays.

Conventional plasma display panels include discharge cells arranged in matrix form. Each of the discharge cells, as shown in FIG. 1, includes an upper substrate 1 providing an image display surface and a lower substrate 3 arranged parallel to the upper substrate 1 by interposing barrier ribs 2.

A plurality of pairs of sustain electrodes 4 each pair including a transparent electrode 4a and bus electrode 4b, an upper dielectric layer 6 and a protective film 8 are formed on the upper substrate 1 in this sequence. Also, address electrodes 5 for causing discharge with the pairs of sustain electrodes 4 and a lower dielectric layer 7 are formed on the lower substrate 3 in this sequence.

Phosphors 9 for generating visible rays having original colors are applied to side surfaces of the barrier ribs 2 and to an upper surface of the lower dielectric layer 7.

The phosphors 9 are excited by vacuum ultraviolet rays of short wavelengths generated upon gas discharge, to thereby generate Red, Green and Blue visible rays.

In the conventional plasma display panels having the above described configuration, the lower dielectric layer 7 and barrier ribs 2 are individually manufactured via different processes from each other.

Specifically, the address electrodes 5 are first formed on the lower substrate 3, and then, the lower dielectric layer 7 is formed over the entire surface of the lower substrate 3 including the address electrodes 5.

Subsequently, after performing a primary heat-treatment process, the barrier ribs 2 are formed on the lower dielectric layer 7, and then, a secondary heat-treatment process is performed.

As stated above, since the lower dielectric layer 7 and barrier ribs 2 are formed by use of different materials and processes from each other, the conventional plasma display panels have a necessity for an increased number of processing equipment and materials, etc. This becomes a reason of increasing the manufacturing costs.

Further, the conventional plasma display panels suffer from deterioration of product quality, such as for example, generation of unnecessary impurities and air bubbles, discoloration of electrodes, deformation of substrates, etc. This is because of the high-temperature heat-treatments.

Accordingly, methods of manufacturing the conventional plasma display panels have many restrictions in the manufacture of inexpensive, high-brightness, high-definition and low-power plasma display panels.

### SUMMARY OF THE INVENTION

Accordingly, the present invention is directed to a plasma display panel and a method of manufacturing the same that substantially obviate one or more problems due to limitations and disadvantages of the related art.

An object of the present invention is to provide a plasma display panel and a method of manufacturing the same in which a barrier rib, lower dielectric layer and electrode are formed by use of nano powder, thereby achieving improvement in optical efficiency and product quality.

Another object of the present invention is to provide a plasma display panel and a method of manufacturing the same in which a lower dielectric layer and barrier rib are integrally formed, resulting in a simplified overall process.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel may use a photosensitive barrier rib, and the photosensitive barrier rib may contain nano-powder.

Here, the photosensitive barrier rib may be a mixture of glass powder and nano-powder, and the nano-powder may be any one of TiO₂ and ZrO₂.

The photosensitive barrier rib may have a composition including 95-55% glass powder and 5-45% nano-powder.

In accordance with another aspect of the present invention, there is provided a plasma display panel comprising: address electrodes formed on a lower substrate over light emitting cell regions and made of conductive material containing nano-powder; a dielectric layer formed over the entire surface of the lower substrate including the address electrodes; and barrier ribs formed on the dielectric layer between the light emitting cell regions.

Here, the nano-powder contained in the electrodes may be at least one of Ni, Pd, Cu and Au. The electrodes may be made of Ag, metal-coated Ag, or any one or combinations of conductive metals.

The metal coated on Ag may be nano-powder containing at least one of Ni, Pd, Cu and Au.

In accordance with a further aspect of the present invention, there is provided a plasma display panel comprising: electrodes formed on a lower substrate over light emitting cell regions; a dielectric layer formed over the entire surface of the lower substrate including the electrodes and containing nano-powder; and barrier ribs formed on the dielectric layer between the light emitting cell regions and containing nano-powder.

Here, the nano-powder contained in the dielectric layer and barrier rib may be any one of TiO₂ and ZrO₂. The dielectric layer and barrier rib may have a composition including 95-55% glass powder and 5-45% nano-powder.

In accordance with another aspect of the present invention, there is provided a plasma display panel comprising: address electrodes formed on a lower substrate over light emitting cell regions; a dielectric layer formed over the entire surface of the lower substrate including the address electrodes; and barrier ribs formed on the dielectric layer between the light emitting cell regions and made of the same material as that of the dielectric layer.

Here, the dielectric layer and barrier rib may contain a mixture of glass powder and nano-powder. The nano-powder may be any one of TiO₂ and ZrO₂.

The dielectric layer and barrier rib may have a composition including 95-55% glass powder and 5-45% nano-powder.

In accordance with yet another aspect of the present invention, there is provided a method of manufacturing a plasma display panel comprising: preparing upper and lower substrates having at least one light emitting cell region; forming electrodes on the upper and lower substrates, respectively, over the light emitting cell region; forming a barrier rib paste on the lower substrate including the electrode and firing the barrier rib paste; etching the barrier rib paste over the light emitting cell region to a predetermined depth, to form a dielectric layer and barrier rib simultaneously; forming phosphors on side surfaces of the barrier rib and on the dielectric layer over the light emitting cell region; and bonding the upper substrate onto the barrier rib.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a conventional plasma display panel;

FIG. 2 is a view illustrating a plasma display panel according to the present invention; and

FIGS. 3A to 3D are sectional views illustrating a process of manufacturing the plasma display panel according to the present invention.

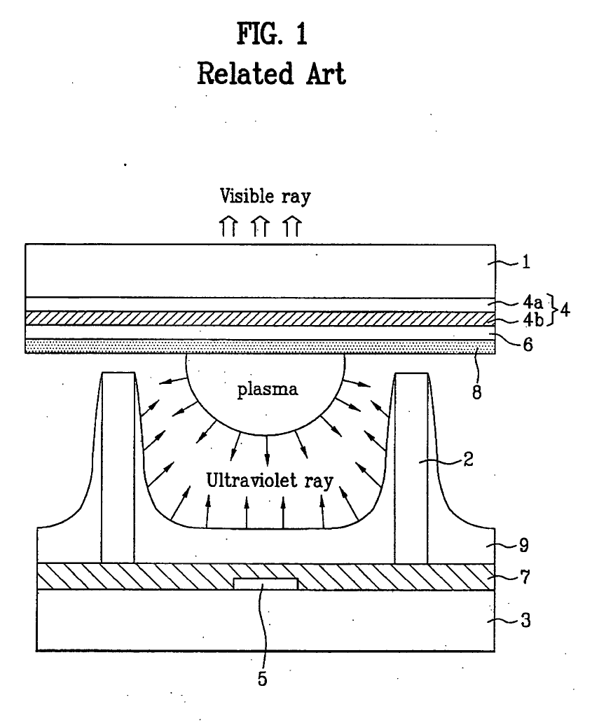

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

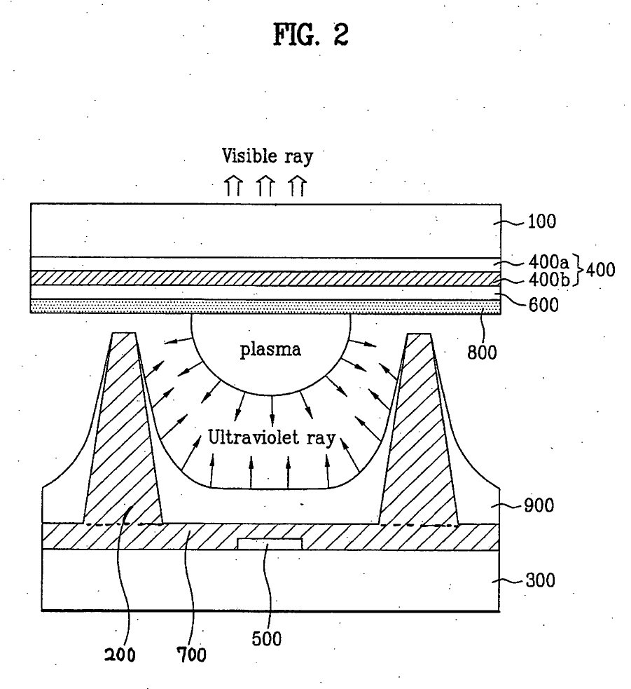

FIG. 2 is a view illustrating a plasma display panel according to the present invention. As shown in FIG. 2, the plasma display panel includes an upper substrate 100 and lower substrate 300 arranged to face each other.

At least one pair of sustain electrodes 400, which include a transparent electrode 400a and bus electrode 400b, an upper dielectric layer 600 and a protective film 800 are formed on the upper substrate 100 at a surface of the upper substrate 100 facing the lower substrate 300.

At least one address electrode 500 for causing discharge with the pair of sustain electrodes 400, a lower dielectric layer 700 and at least one barrier rib 200 are formed on the lower substrate 300 in this sequence.

Here, side surfaces of the barrier rib 200 may be vertically formed or obliquely formed.

If the side surfaces of the barrier rib 200 are obliquely formed, an inclination angle between the side surfaces of the barrier rib 200 and a corresponding surface of the lower dielectric layer 700 may be an acute or obtuse angle.

The lower dielectric layer 700 and barrier rib 200 may be made of the same material as each other or different materials from each other.

Specifically, in one example, the lower dielectric layer 700 and barrier rib 200 may be made of a material obtained by mixing filler, such as TiO₂, Al₂O₃, etc., into glass powder such as PbO, non-PbO, etc.

In another example, the lower dielectric layer 700 and barrier rib 200 may be made of a material obtained by mixing nano-size nucleation promoter, such as TiO₂, ZrO₂, etc., into glass powder such as PbO, non-PbO, etc.

Here, the nano-size nucleation promoter exists between micro-size glass powder particles, and creates dense crystallized glass.

In yet another example, the lower dielectric layer 700 and barrier rib 200 may be made of a material obtained by mixing filler, such as TiO₂, Al₂O₃, etc., and nano-size nucleation promoter, such as TiO₂, ZrO₂, etc., into glass powder such as PbO, non-PbO, etc.

Preferably, the lower dielectric layer 700 and barrier rib 200 may have a composition including approximately 95-55% glass powder and approximately 5-45% filler or nucleation promoter.

The lower dielectric layer 700 and barrier rib 200, made of the above mentioned materials, have an outstanding reflectivity of visual light rays, and therefore, can perform the role of a lower substrate dielectric layer.

Preferably, the lower dielectric layer 700 has a thickness of approximately 10 μm to 30 μm, and the barrier rib 200 has a thickness of approximately 120 μm to 150 μm.

Meanwhile, the address electrode 500 may be made of material selected from among Ag, metal-coated Ag, any one or combinations of conductive metals, or the like.

When the address electrode 500 is made of metal-coated Ag, metal coated on Ag is any one material selected from among Ni, Pd, Cu, Au, etc., and takes the form of nano-size powder.

Then, phosphors 900 are formed on an upper surface of the lower dielectric layer 700 and the side surfaces of the barrier rib 200.

At least one surface of the lower substrate 300, namely, front and/or rear surface of the lower substrate 300, may be subjected to a surface treatment for achieving a desired reflectivity.

For example, the surface of the lower substrate 300 may be partially etched by use of mechanical or physicochemical method, to achieve a smooth surface.

Thereby, the lower substrate 300 can achieve an improved reflectivity of visible light rays. This results in an increase in optical efficiency of the plasma display panel.

The plasma display panel according to the present invention having the above described configuration can be manufactured in accordance with a variety of embodiments.

The present invention uses a photosensitive barrier rib, and the photosensitive barrier rib may contain nano-powder.

The photosensitive barrier rib is made of a mixture of glass powder and nano-powder.

Preferably, the nano-powder may be any one of TiO₂ and ZrO₂, and the photosensitive barrier rib may have a composition including 95-55% glass powder and 5-45% nano powder.

In the present invention, the address electrode may be made of conductive material containing nano-powder.

Here, the nano-powder contained in the electrode may be at least one of Ni, Pd, Cu and Au, and the electrode may be made of Ag, metal-coated Ag, or any one or combinations of conductive metals.

Also, metal coated on Ag may be nano-powder containing at least one of Ni, Pd, Cu and Au.

In the present invention, the lower dielectric layer and barrier rib may be made of material containing nano-powder.

Here, the nano-powder contained in the lower dielectric layer and barrier rib may be any one of TiO₂ and ZrO₂, and the lower dielectric layer and barrier rib may have a composition including 95-55% glass powder and 5-45% nano powder.

Now, a method of manufacturing the plasma display panel of the present invention having the above described configuration will be explained.

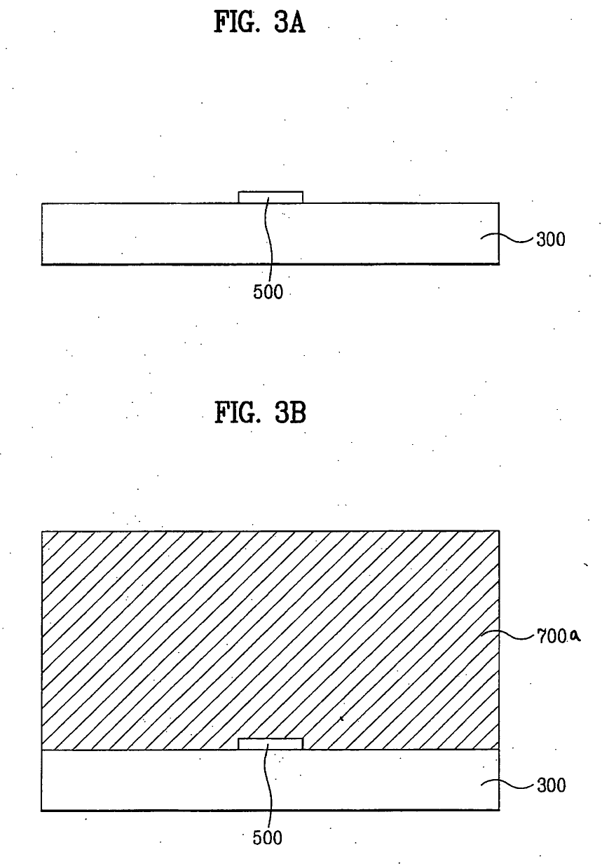

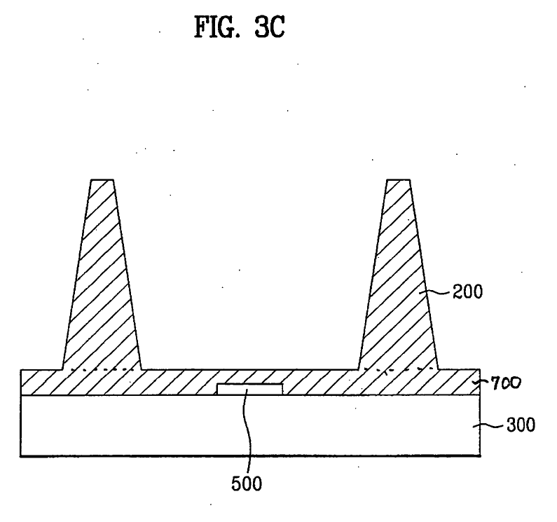

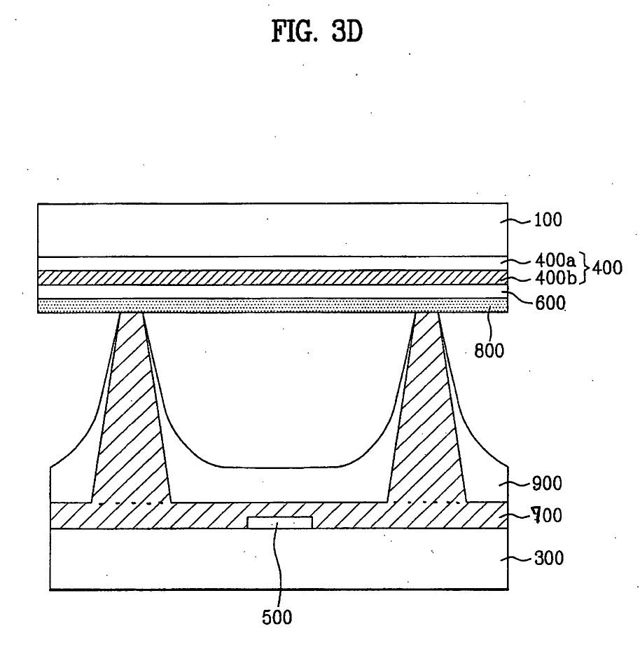

FIGS. 3A to 3D are sectional views illustrating a process for manufacturing the plasma display panel according to the present invention.

Referring firstly to FIG. 3A, the lower substrate 300 is prepared.

Here, at least one surface of the lower substrate 300, more particularly, front and/or rear surface of the lower substrate 300 may be subjected to a surface treatment to achieve a desired reflectivity.

The surface treatment of the lower substrate 300 is performed by partially etching the surface of the lower substrate 300 via mechanical or physicochemical method. With this surface treatment, the lower substrate 300 can achieve an increased reflection of visible light rays.

Subsequently, the address electrode 500 is formed on the lower substrate 300 over a light emitting cell region.

Here, the address electrode 500 may be made of conductive material containing nano-powder.

Specifically, the address electrode 500 may be made of Ag, metal coated Ag, or any one or combinations of conductive metals.

When the address electrode 500 is made of metal-coated Ag, metal coated on Ag is any one material selected from among Ni, Pd, Cu, Au, etc., and takes the form of nano-size powder.

Referring secondly to FIG. 3B, a barrier rib paste 700a is formed over the entire surface of the lower substrate 300 including the address electrode 500, and then, is fired.

Here, the barrier rib paste 700a is prepared by mixing filler and nano-size nucleation promoter, etc. into glass powder, and then, mixing the resulting powder into organic solvent.

The glass powder is selected from among Pb, non-PbO, etc., and the filler is selected from among TiO₂, Al₂O₃, etc. Also, the nucleation promoter is selected from among TiO₂, ZrO₂, etc.

Preferably, the barrier rib paste 700a has a thickness of approximately 120 μm to 150 μm, and is fired at a temperature of approximately 550° C. to 600° C.

Referring thirdly to FIG. 3C, the barrier rib paste 700a over the light emitting cell region is etched to a predetermined depth, to form the lower dielectric layer 700 and barrier rib 200 simultaneously.

Here, the barrier rib paste 700a may be etched by use of sand blasting, direct etching and photolithography methods, etc., to etch the light emitting cell region.

Preferably, the etching depth of the barrier rib paste 700a is in the range of approximately 110 μm to 140 μm.

Referring finally to FIG. 3D, after forming the phosphors 900 on the side surfaces of the barrier rib 200 and the upper surface of the lower dielectric layer 700, the upper substrate 100, on which the pair of sustain electrodes 400, upper dielectric layer 600 and protective film 800 are formed in this sequence, is bonded onto the barrier rib 200, completing the manufacture of the plasma display panel.

As apparent from the above description, the plasma display panel according to the present invention has the following effects.

Firstly, as a result of eliminating a process for forming a dielectric layer on a lower substrate, the present invention can achieve a simplified overall process and reduced manufacturing costs.

Secondly, by virtue of the fact that the present invention is free from many problems caused by the process for forming a dielectric layer on a lower substrate, the present invention can achieve the effects of improving optical efficiency and product quality.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel using a photosensitive barrier rib, wherein
the photosensitive barrier rib contains nano-powder.

2. The panel according to claim 1, wherein the photosensitive barrier rib contains a mixture of glass powder and nano-powder.

3. The panel according to claim 1, wherein the nano-powder is any one of TiO₂ and ZrO₂.

4. The panel according to claim 1, wherein the photosensitive barrier rib has a composition including 95-55% glass powder and 5-45% nano-powder.

5. A plasma display panel having a plurality of light emitting cells between an upper substrate and a lower substrate comprising:
address electrodes formed on the lower substrate and made of conductive material containing nano-powder;
a dielectric layer formed over the entire surface of the lower substrate including the address electrodes; and
barrier ribs formed on the dielectric layer.

6. The panel according to claim 5, wherein the nano-powder contained in the electrodes is at least one of Ni, Pd, Cu and Au.

7. The panel according to claim 5, wherein the electrodes are made of Ag, metal-coated Ag, or any one or combinations of conductive metals.

8. The panel according to claim 7, wherein the metal coated on Ag is nano-powder containing at least one of Ni, Pd, Cu and Au.

9. A plasma display panel having a plurality of light emitting cells between an upper substrate and a lower substrate comprising:
electrodes formed on the lower substrate;
a dielectric layer formed over the entire surface of the lower substrate including the electrodes and containing nano-powder; and
barrier ribs formed on the dielectric layer and containing nano-powder.

10. The panel according to claim 9, wherein the nano-powder contained in the dielectric layer and barrier rib is any one of TiO₂ and ZrO₂.

11. The panel according to claim 9, wherein the dielectric layer and barrier rib have a composition including 95-55% glass powder and 5-45% nano-powder.

12. A plasma display panel having a plurality of light emitting cells between an upper substrate and a lower substrate comprising:
address electrodes formed on the lower substrate;
a dielectric layer formed over the entire surface of the lower substrate including the address electrodes; and
barrier ribs formed on the dielectric layer and made of the same material as that of the dielectric layer.

13. The panel according to claim 12, wherein the dielectric layer and barrier rib contain a mixture of glass powder and nano-powder.

14. The panel according to claim 13, wherein the nano-powder is any one of TiO₂ and ZrO₂.

15. The panel according to claim 13, wherein the dielectric layer and barrier rib have a composition including 95-55% glass powder and 5-45% nano-powder.

16. A method of manufacturing a plasma display panel comprising:
preparing upper and lower substrates having a light emitting cell region;
forming electrodes on the upper and lower substrates, respectively, over the light emitting cell region;
forming a barrier rib paste on the lower substrate including the electrode and firing the barrier rib paste;
etching the barrier rib paste over the light emitting cell region to a predetermined depth, to form a dielectric layer and barrier rib simultaneously;
forming phosphors on side surfaces of the barrier rib and on the dielectric layer over the light emitting cell region; and
bonding the upper substrate onto the barrier rib.

17. The method according to claim 13, wherein, in the preparation of the lower substrate, at least one surface of the lower substrate, namely, front and/or rear surface of the lower substrate, is subjected to a surface treatment, to achieve a desired reflectivity.

18. The method according to claim 16, wherein the barrier rib paste is formed by mixing nano-powder into glass powder and organic solvent.

19. The method according to claim 16, wherein a firing temperature of the barrier rib paste is in the range of 550° C. to 600° C.

20. The method according to claim 16, wherein, in the etching of the barrier rib paste, the predetermined etching depth is in the range of 110 μm to 140 μm.
